(19) United States
(12) Patent Application Publication
(10) Pub. No.: US 2017/0255724 A1
(43) Pub. Date: Sep. 7, 2017

(54) Enhanced Global Design Variables Used In Structural Topology Optimization Of A Product In An Impact Event

(71) Applicant: Livermore Software Technology Corporation, Livermore, CA (US)

(72) Inventor: Willem J. Roux, Livermore, CA (US)

(21) Appl. No.: 15/062,575

(22) Filed: Mar. 7, 2016

(51) Int. Cl. G06F 17/50

(52) U.S. Cl. CPC G06F 17/5018; G06F 17/5095

(57) ABSTRACT

Enhanced global design variables used in structural topology optimization are disclosed. FEA model of a product's initial candidate design along with design objective and constraint, and initial global design variables are received. Field design variables are then initialized. Simulated structural responses including computed IED distribution and design constraints and objectives of the product are obtained by performing a time-marching simulation of the impact event using the FEA model. New values of global design variables are computed based on computed design constraints and objectives, A target IED distribution defined by the sum of a set of mathematical functions with each function scaled by a corresponding global design variable for next candidate design is established. Field design variables are then updated using the differences of the target IED distribution and the computed IED distribution. Simulated structural responses are obtained until the current candidate design is deemed to be optimal.

### FIELD

The present invention generally relates to computer aided engineering design, more particularly to improved methods and systems for performing structural topology design optimization of a product.

### BACKGROUND

Today, computer aided engineering (CAE) has been used for supporting engineers in tasks such as analysis, simulation, design, manufacture, etc. In a conventional engineering design procedure, CAE analysis (e.g., finite element analysis (FEA), finite difference analysis, meshless analysis, computational fluid dynamics (CFD) analysis, modal analysis for reducing noise-vibration-harshness (NVH), etc.) has been employed to evaluate responses (e.g., stresses, displacements, etc.). Using automobile design as an example, a particular version or design of a car is analyzed using FEA to obtain the responses due to certain loading conditions. Engineers will then try to improve the car design by modifying certain parameters or design variables (e.g., thickness of the steel shell, locations of the frames, etc.) based on specific objectives and constraints. Another FEA is conducted to reflect these changes until a “best” design has been achieved. However, this approach generally depends on knowledge of the engineers or based on a trial-and-error method. To solve this problem, a systematic approach (referred to as design optimization) to identify the “best” design is used.

Traditionally, design optimization is performed with a computer system and generally divided into three categories, sizing, shape and topology. Structural topology design optimization is best suited for creating optimal conceptual design in which the user (i.e., engineer, designer, etc.) does not have put too many constraints as to the shape and/or size of the engineering product. However, there are problems associated with structural topology design optimization especially for the topology design optimization of a component of a complex structure (e.g., automobile, airplane, etc.). Non-linear structure responses (e.g., design constraints) of the complex product make the progress of the structural topology design optimization difficult to predict. In particular, at each stage of the topology design optimization, the new candidate design is computed using some arbitrary or ad hoc formula for the relationship between the constraints and design variables. As a result, the structural topology optimization procedure can fail or can be overly expensive.

Furthermore, when topology design optimization used in a highly nonlinear impact event (e.g., vehicle crash), prior approaches cannot take certain vehicle occupant safety criteria into consideration. For example, design of the stiffest structure of vehicle would result in peak force dangerous to the vehicle occupants.

A prior art approach designates part(s) in a vehicle in a vehicle as global design variable(s). Such an approach can result in too stiff a part, which is lethal to the vehicle occupants. The results may be improved by subdividing a design part into a number of smaller design parts. However, it is not practical due to expensive computational power, excessive labor costs, and delay.

Therefore, it would be desirable to have improved methods and systems for performing structural topology design optimization using enhanced global design variables for a product in an impact event.

### BRIEF SUMMARY

This section is for the purpose of summarizing some aspects of the present invention and to briefly introduce some preferred embodiments. Simplifications or omissions in this section as well as in the abstract and the title herein may be made to avoid obscuring the purpose of the section. Such simplifications or omissions are not intended to limit the scope of the present invention.

Methods and systems for performing structural topology design optimization of a product in an impact event using enhanced global design variables are disclosed. According to one aspect of the present invention, a definition of a FEA model of the product's design domain as an initial candidate design along with a design objective, at least one design constraint and initial values of a set of global design variables are received in a computer system having one or more application module installed thereon. Initial values of field design variables are then assigned based on the initial values of the global design variables. Simulated structural responses of the product are obtained by performing a time-marching simulation of the impact event using the FEA model. The simulated structural responses include computed internal energy density (IED) distribution, computed design objectives and constraints. The current candidate design is determined whether it is deemed to be optimal based on predefine criteria. If not, new values of global design variables are computed based on computed design constraints and objectives, A target IED distribution for next candidate design is established. The target IED distribution is defined by the sum of a set of mathematical functions with each function scaled by a corresponding global design variable. The field design variables are then updated using the differences of the target IED distribution and the computed IED distribution. Simulated structural responses are obtained for the current candidate design until the current candidate design is deemed to be optimal.

Objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will be better understood with regard to the following description, appended claims, and accompanying drawings as follows:

FIG. 1 is a flowchart illustrating an example process of conducting structural topology design optimization using enhanced global design variables for a product in an impact event according to one embodiment of the present invention;

FIG. 2 shows a first set of example mathematical functions for establishing a target internal energy density distribution of the product in accordance with one embodiment of the present invention;

FIG. 3 shows a second set of example mathematical functions for establishing a target internal energy density distribution of the product in accordance with one embodiment of the present invention;

FIG. 4 shows a first example candidate design of the product in a structural topology design optimization using enhanced global design variables according to one embodiment of the present invention;

FIG. 4 shows a second example candidate design of the product in a structural topology design optimization using enhanced global design variables according to one embodiment of the present invention; and

FIG. 6 is a function diagram showing salient components of a computing device, in which an embodiment of the present invention may be implemented.

### DETAILED DESCRIPTION

In the following description, numerous specific details are set forth in order to provide a thorough understanding of the present invention. However, it will become obvious to those skilled in the art that the present invention may be practiced without these specific details. The descriptions and representations herein are the common means used by those experienced or skilled in the art to most effectively convey the substance of their work to others skilled in the art. In other instances, well-known methods, procedures, and components have not been described in detail to avoid unnecessarily obscuring aspects of the present invention.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Additionally, the term “optimal design” in this document is intended to indicate a design that meets the design requirements (e.g., goal, objective and constraints) in an iterative optimization design process. Furthermore, the terms “optimal configuration”, “optimal design”, “substantially improved design”, “significantly improved design” and “final design” are used interchangeably throughout this document. Finally, the order of blocks in process flowcharts or diagrams representing one or more embodiments of the invention do not inherently indicate any particular order nor imply any limitations in the invention.

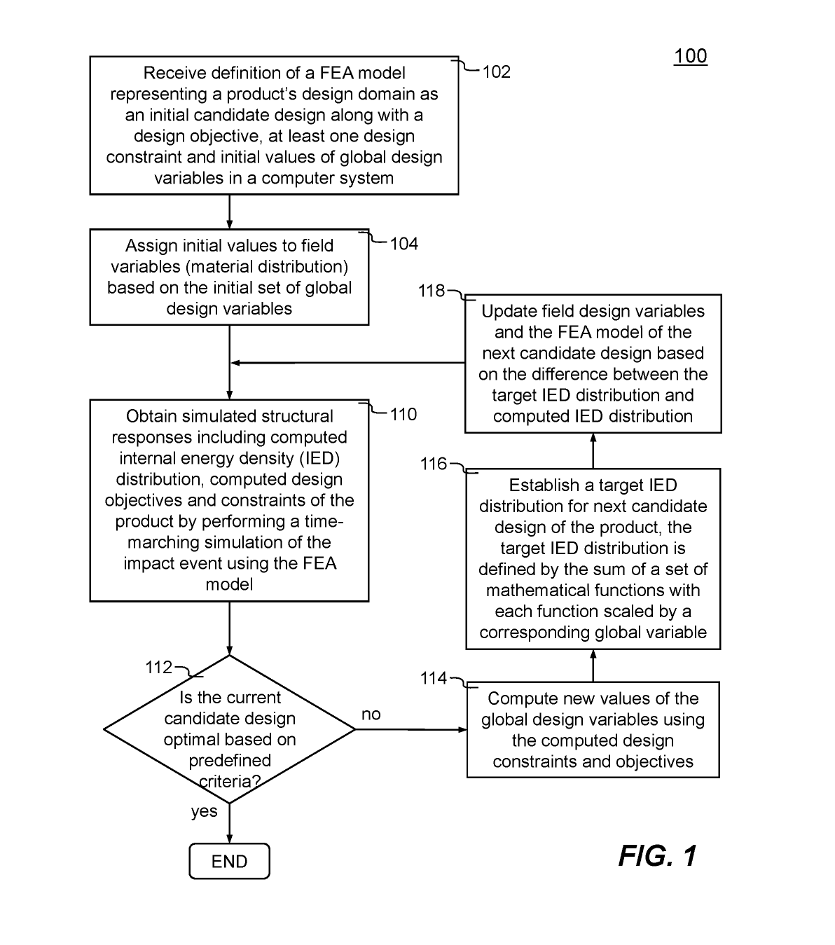

Embodiments of the present invention are discussed herein with reference to FIGS. 1-6. However, those skilled in the art will readily appreciate that the detailed description given herein with respect to these figures is for explanatory purposes as the invention extends beyond these limited embodiments.

The mathematical basis of structural topology optimization using global design variables is described below.

Write a function F (either design objective or constraint) as:
F=F(x) with the field design variables x represent the material distribution.
   Computing x from η (the global design variables), allows us to write

F=F(x)=F(x(η))=F(η)

Now the standard optimization problem can be solved as:

Minimize F(η) subject Gᵢ(η))<0.

where:
i represents the i-th design constraint, that is, i=1, . . . , n for n constraints.
Specifically the design objective can be the mass of the structure while G represents the occupant safety.

Referring first to FIG. 1, it is shown a flowchart illustrating an example process 100 of conducting structural topology design optimization using enhanced global variables for a product in an impact event according to an embodiment of the present invention. Process 100 is preferably implemented in software and understood with other figures. In one embodiment, the product is an automobile while the impact event is a car crash test. In another embodiment, the product is a consumer product (e.g., electronic device) while the impact event is a drop test.

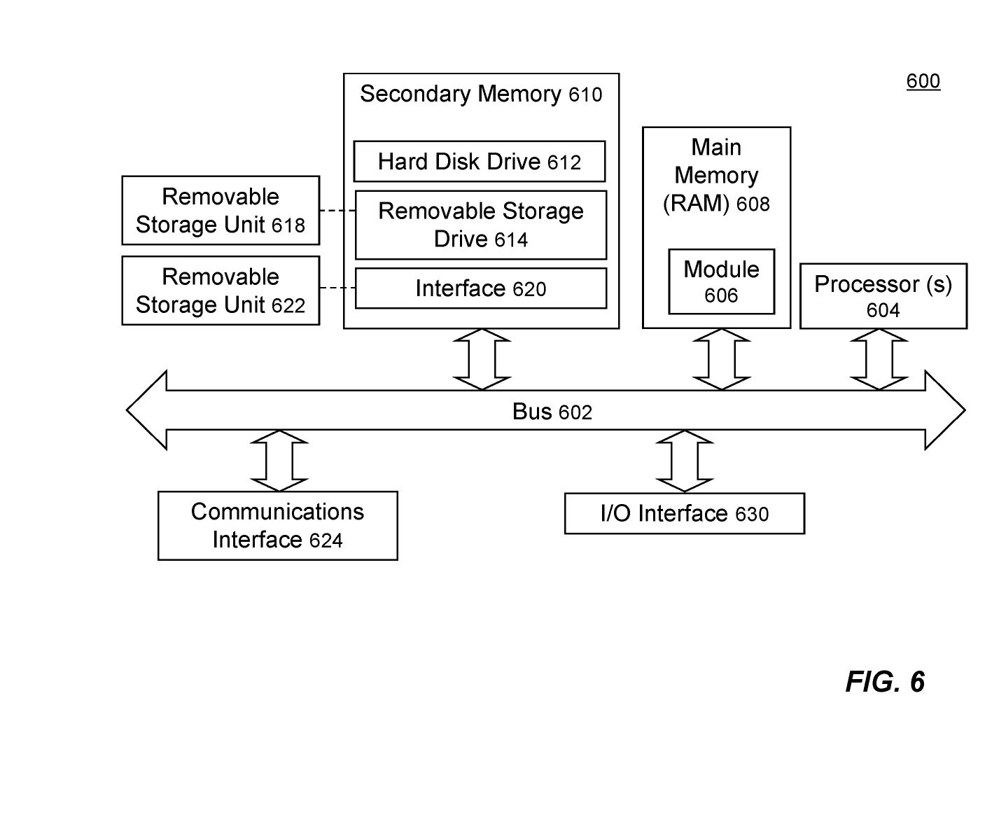

Process 100 starts, at action 102, by receiving a definition of a finite element analysis (FEA) model of a product's design domain as an initial candidate design along with a design objective, at least one design constraint and initial values of a set of global design variables in a computer system (e.g., computer 600 of FIG. 6) having one or more application modules (e.g., finite element analysis (FEA) application module, structural topology design optimization application module, etc.) installed thereon.

At action 104, a set of field design variables are initialized based on the initial values of the global design variables. In one embodiment, material distribution of the product can be represented the field design variables, for example, the mass density of each finite element of the FEA model is a field design variable.

Next, at action 110, the simulated structural responses of the product are obtained by conducting a time-marching simulation of the impact event using the FEA model of the candidate design in a computer system. The simulated structural responses include computed internal energy density (IED) distribution, computed design objectives and computed design constraints. Another example response that is important for occupant safety in an automobile crash is the impact pulse at the location of the occupant.

Next, at decision 112, the current candidate design is checked to determine whether an optimal design has achieved based on predefined criteria. For example, the change of the current candidate design from the immediately prior candidate design is smaller than a predetermined percentage or value, then the optimization can be declared converged (i.e., decision 112 is true).

If decision 112 is false, process 100 follows the ‘no’ branch to action 114. New values of the global design variables are computed using the computed design objectives and constraints obtained at action 110.

Next, at action 116, a target IED distribution for the next candidate design of the product is established. The target IED distribution is defined by a sum of a number of mathematical functions with each function scaled by a corresponding one of the global design variables.

The IED distribution (either computed using FEA or prescribed using global design variables) is a measure of the structural performance in an impact event. Generally, a stiffer part is obtained by decreasing the target IED Enhanced global design variables therefore effective control the stiffness variation in a structure by controlling the target IED distribution variation

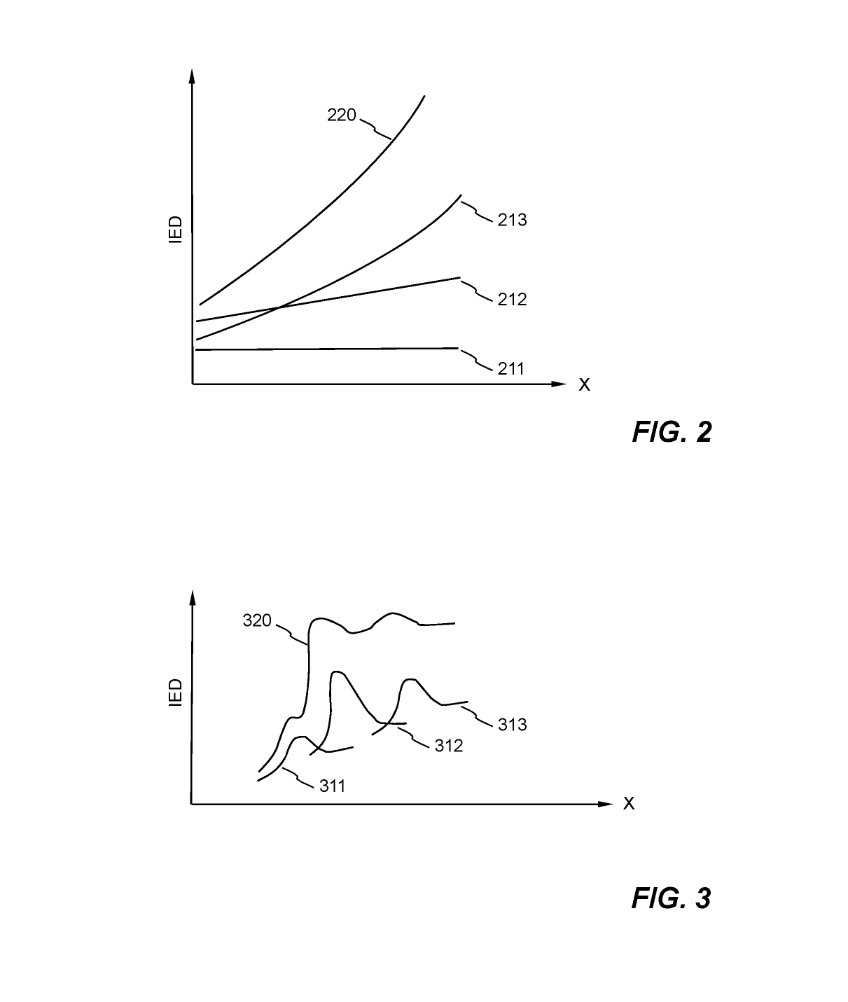

In one embodiment, the set of mathematical functions are polynomial functions. Shown in FIG. 2, a set of global design variables are the coefficients to scale each of the polynomial functions 211-213 to form the target IED distribution 220. The target IED distribution 220 can also be express in form of an equation as follows:

IED(X)=A₀+A₁X+A₂X²

where:
IED(X) is the target internal energy density distribution.
X is an arbitrary direction in space.
A₀, A₁, A₂ are a set of global design variables.

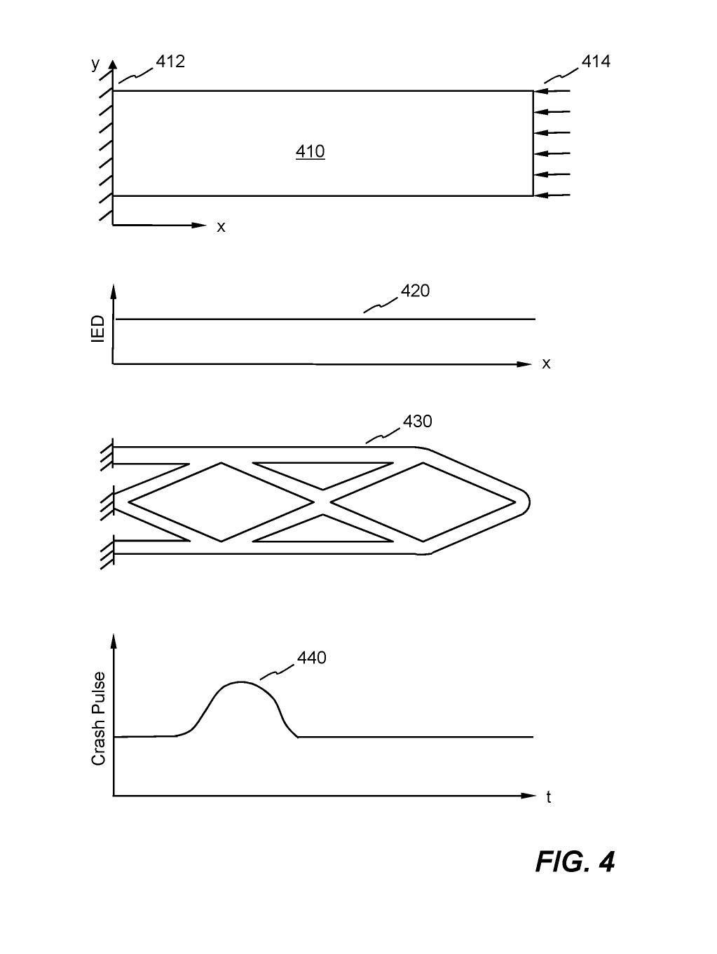

In another embodiment, the set of mathematical functions are radial basis functions. FIG. 3 shows three such a radial basis functions 311-313. Each of the radial basis functions 311-313 is scaled by a corresponding user-specified global design variable to form or establish the target IED distribution 320.

Next, at action 118, the field variables and corresponding FEA model of the next candidate design are updated in accordance with the differences between the target IED distribution and the computed IED distribution. This can be done with known topology optimization techniques.

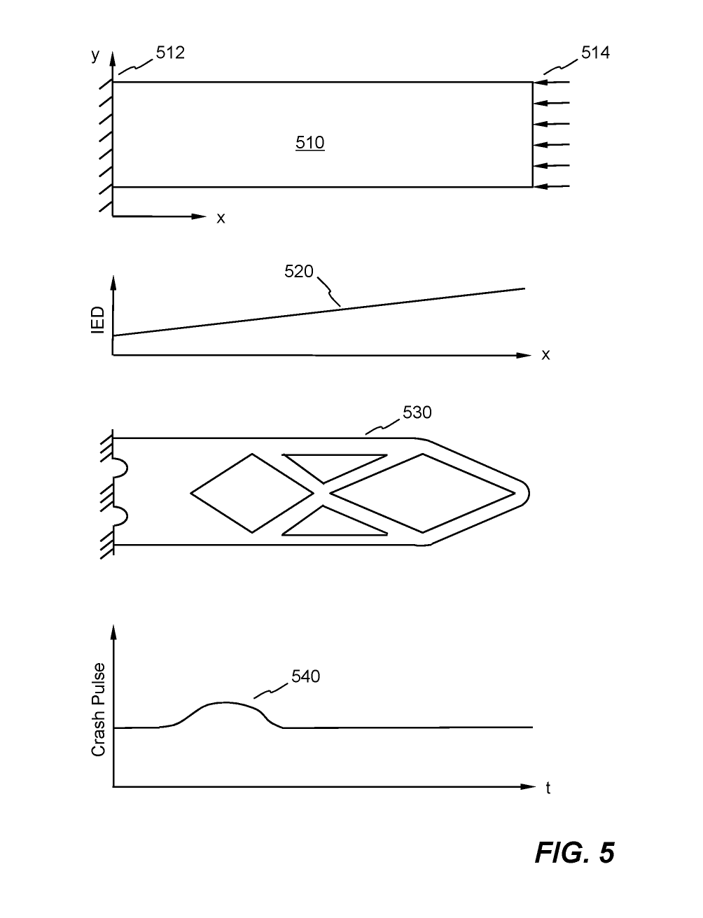

In a first embodiment, a material distribution of a first example candidate design is shown in FIG. 4. The first example design domain 410 of a product (i.e., a rectangular shape plate) under an impact load (shown as arrows 414). The first example design domain 410 has a fixed end boundary 412. A first example target IED distribution 420 is a constant over the span of the design domain. For illustration simplicity and clarity, target IED values are only shown in dimension “x”. The IED values are uniform throughout dimension “y” of the rectangular shape plate. The first example candidate design 430 is a result of using the first example target IED distribution.

In the second embodiment, a material distribution of a second example candidate design is shown in FIG. 5. The second example design domain 510 is exactly the same as the first example design domain 410 subject to the same impact loading 514 and fixed end boundary 512. The second example target IED distribution 520 varies over the span of the design domain with lower IED at the fixed end boundary 512. Similar to FIG. 4, target IED values are shown in dimension “x”. The IED values are uniform in dimension “y”. The second example candidate design 530 has a higher stiffness (and mass) towards the fixed end comparing to the first example candidate design 430.

Referring back to FIG. 1, process 100 goes back to action 110 to obtain simulated structural responses of the product using the updated FEA model (representing the current candidate design i.e., the next candidate design of actions 116 and 118). Process 100 ends when decision 112 becomes true. Otherwise, process 100 repeats the actions for another candidate design (i.e., new values of global design variables).

Finally, impact pulse 440 shown in FIG. 4 is higher than the impact pulse 540 shown in FIG. 5. In these two examples, the second candidate design may provide better occupant safety.

According to one aspect, the present invention is directed towards one or more computer systems capable of carrying out the functionality described herein. An example of a computer system 600 is shown in FIG. 6. The computer system 600 includes one or more processors, such as processor 604. The processor 604 is connected to a computer system internal communication bus 602. Various software embodiments are described in terms of this exemplary computer system. After reading this description, it will become apparent to a person skilled in the relevant art(s) how to implement the invention using other computer systems and/or computer architectures.

Computer system 600 also includes a main memory 608, preferably random access memory (RAM), and may also include a secondary memory 610. The secondary memory 610 may include, for example, one or more hard disk drives 612 and/or one or more removable storage drives 614, representing a floppy disk drive, a magnetic tape drive, an optical disk drive, etc. The removable storage drive 614 reads from and/or writes to a removable storage unit 618 in a well-known manner. Removable storage unit 618, represents a floppy disk, magnetic tape, optical disk, etc. which is read by and written to by removable storage drive 614. As will be appreciated, the removable storage unit 618 includes a computer usable storage medium having stored therein computer software and/or data.

In alternative embodiments, secondary memory 610 may include other similar means for allowing computer programs or other instructions to be loaded into computer system 600. Such means may include, for example, a removable storage unit 622 and an interface 620. Examples of such may include a program cartridge and cartridge interface (such as that found in video game devices), a removable memory chip (such as an Erasable Programmable Read-Only Memory (EPROM), Universal Serial Bus (USB) flash memory, or PROM) and associated socket, and other removable storage units 622 and interfaces 620 which allow software and data to be transferred from the removable storage unit 622 to computer system 600. In general, Computer system 600 is controlled and coordinated by operating system (OS) software, which performs tasks such as process scheduling, memory management, networking and I/O services.

There may also be a communications interface 624 connecting to the bus 602. Communications interface 624 allows software and data to be transferred between computer system 600 and external devices. Examples of communications interface 624 may include a modem, a network interface (such as an Ethernet card), a communications port, a Personal Computer Memory Card International Association (PCMCIA) slot and card, etc. The computer 600 communicates with other computing devices over a data network based on a special set of rules (i.e., a protocol). One of the common protocols is TCP/IP (Transmission Control Protocol/Internet Protocol) commonly used in the Internet. In general, the communication interface 624 manages the assembling of a data file into smaller packets that are transmitted over the data network or reassembles received packets into the original data file. In addition, the communication interface 624 handles the address part of each packet so that it gets to the right destination or intercepts packets destined for the computer 600. In this document, the terms “computer program medium” and “computer usable medium” are used to generally refer to media such as removable storage drive 614, and/or a hard disk installed in hard disk drive 612. These computer program products are means for providing software to computer system 600. The invention is directed to such computer program products.

The computer system 600 may also include an input/output (I/0) interface 630, which provides the computer system 600 to access monitor, keyboard, mouse, printer, scanner, plotter, and alike.

Computer programs (also called computer control logic) are stored as application modules 606 in main memory 608 and/or secondary memory 610. Computer programs may also be received via communications interface 624. Such computer programs, when executed, enable the computer system 600 to perform the features of the present invention as discussed herein. In particular, the computer programs, when executed, enable the processor 604 to perform features of the present invention. Accordingly, such computer programs represent controllers of the computer system 600.

In an embodiment where the invention is implemented using software, the software may be stored in a computer program product and loaded into computer system 600 using removable storage drive 614, hard drive 612, or communications interface 624. The application module 606, when executed by the processor 604, causes the processor 604 to perform the functions of the invention as described herein.

The main memory 608 may be loaded with one or more application modules 606 that can be executed by one or more processors 604 with or without a user input through the I/0 interface 630 to achieve desired tasks. In operation, when at least one processor 604 executes one of the application modules 606, the results are computed and stored in the secondary memory 610 (i.e., hard disk drive 612). The status of the CAE analysis or structural design topology optimization (e.g., candidate design at each iteration) is reported to the user via the I/O interface 630 either in a text or in a graphical representation.

Although the present invention has been described with reference to specific embodiments thereof, these embodiments are merely illustrative, and not restrictive of, the present invention. Various modifications or changes to the specifically disclosed exemplary embodiments will be suggested to persons skilled in the art. For example, whereas the examples have been shown and described in two-dimensional (i.e., dimensions “x” and “y”), the present invention does not set such limit, dimensions “x” and “y” can be extended to three-dimensional to achieve the same. In summary, the scope of the invention should not be restricted to the specific exemplary embodiments disclosed herein, and all modifications that are readily suggested to those of ordinary skill in the art should be included within the spirit and purview of this application and scope of the appended claims.

I claim:

1. A method of conducting structural topology design optimization of a product in an impact event, the method comprising:
receiving, in a computer system having at least one application module installed thereon, a definition of a finite element analysis (FEA) model representing the product's design domain as an initial candidate design along with a design objective, at least one design constraint and initial values of a plurality of global design variables;
assigning, with said at least one application module, initial values of a plurality of field design variables based on the initial values of the global design variables;
(a) obtaining, with said at least one application module, simulated structural responses of the product by performing a time-marching simulation of the impact event using the FEA model, the simulated structural responses including computed internal energy density (IED) distribution, computed design objective and computed design constraint;
(b) determining, with said at least one application module, whether the current candidate design is deemed to be optimal based on predefined criteria;
if the current candidate design is determined not optimal at (b),
(c) computing, with said at least one application module, new values of the global design variables using the simulated structural responses;
(d) establishing, with said at least one application module, a target IED distribution for the next candidate design of the product, the target IED distribution being defined by a sum of a plurality of mathematical functions with each function scaled by a corresponding one of the global design variables;
(e) updating, with said at least one application module, the field design variables and the FEA model of the next candidate design of the product based on differences between the target IED distribution and the computed IED distribution;
(f) repeating, with said at least one application module, (a)-(b) until the candidate design of the product is deemed to be optimal at (b).

2. The method of claim 1, wherein the plurality of mathematical functions comprises polynomial functions.

3. The method of claim 1, wherein the plurality of mathematical functions comprises radial basis functions.

4. The method of claim 1, wherein the product's target IED distribution influences the product's stiffness and mass distribution.

5. The method of claim 1, wherein the product is an automobile and the impact event is a car crash event.

6. The method of claim 5, wherein the simulated structural responses comprise a crash pulse.

7. The method of claim 1, wherein the set of field design variables comprise mass density of each finite element of the FEA model.

8. A system for conducting structural topology design optimization of a product in an impact event, the system comprising:
a main memory for storing computer readable code for one or more application modules;
at least one processor coupled to the main memory, said at least one processor executing the computer readable code in the main memory to cause said one or more application modules to perform operations by a method of:
receiving a definition of a finite element analysis (FEA) model representing the product's design domain as an initial candidate design along with a design objective, at least one design constraint and initial values of a plurality of global design variables;
assigning initial values of a plurality of field design variables based on the initial values of the global design variables;
(a) obtaining simulated structural responses of the product by performing a time-marching simulation of the impact event using the FEA model, the simulated structural responses including computed internal energy density (IED) distribution, computed design objective and computed design constraint;
(b) determining whether the current candidate design is deemed to be optimal based on predefined criteria;
if the current candidate design is determined not optimal at (b),
(c) computing new values of the global design variables using the simulated structural responses;
(d) establishing a target IED distribution for the next candidate design of the product, the target IED distribution being defined by a sum of a plurality of mathematical functions with each function scaled by a corresponding one of the global design variables;
(e) updating with said at least one application module, the field design variables and the FEA model of the next candidate design of the product based on differences between the target IED distribution and the computed IED distribution;
(f) repeating (a)-(b) until the candidate design of the product is deemed to be optimal at (b).

9. The system of claim 8, wherein the plurality of mathematical functions comprises polynomial functions.

10. The system of claim 8, wherein the plurality of mathematical functions comprises radial basis functions.

11. The system of claim 8, wherein the product's target TED distribution influences the product's stiffness and mass distribution.

12. The system of claim 8, wherein the product is an automobile and the impact event is a car crash event.

13. The system of claim 12, wherein the simulated structural responses comprise a crash pulse.

14. The system of claim 8, wherein the set of field design variables comprise mass density of each finite element of the FEA model.

15. A non-transitory computer-readable storage medium containing instructions for conducting structural topology design optimization of a product in an impact event by a method comprising:
receiving, in a computer system having at least one application module installed thereon, a definition of a finite element analysis (FEA) model representing the product's design domain as an initial candidate design along with a design objective, at least one design constraint and initial values of a plurality of global design variables;
assigning, with said at least one application module, initial values of a plurality of field design variables based on the initial values of the global design variables;
(a) obtaining, with said at least one application module, simulated structural responses of the product by performing a time-marching simulation of the impact event using the FEA model, the simulated structural responses including computed internal energy density (IED) distribution, computed design objective and computed design constraint;
(b) determining, with said at least one application module, whether the current candidate design is deemed to be optimal based on predefined criteria;
if the current candidate design is determined not optimal at (b),
(c) computing, with said at least one application module, new values of the global design variables using the simulated structural responses;
(d) establishing, with said at least one application module, a target TED distribution for the next candidate design of the product, the target TED distribution being defined by a sum of a plurality of mathematical functions with each function scaled by a corresponding one of the global design variables;
(e) updating, with said at least one application module, the field design variables and the FEA model of the next candidate design of the product based on differences between the target IED distribution and the computed IED distribution;
(f) repeating, with said at least one application module, (a)-(b) until the candidate design of the product is deemed to be optimal at (b).

16. The non-transitory computer-readable storage medium of claim 15, wherein the plurality of mathematical functions comprises polynomial functions.

17. The non-transitory computer-readable storage medium of claim 15, wherein the plurality of mathematical functions comprises radial basis functions.

18. The non-transitory computer-readable storage medium of claim 15, wherein the product's target TED distribution influences the product's stiffness and mass distribution.

19. The non-transitory computer-readable storage medium of claim 15, wherein the product is an automobile and the impact event is a car crash event.

20. The non-transitory computer-readable storage medium of claim 19, wherein the simulated structural responses comprise a crash pulse.
